(19) United States
(12) Patent Application Publication
(10) Pub. No.: US 2024/0055024 A1
(43) Pub. Date: Feb. 15, 2024

(54) GENERATING AND MIXING AUDIO ARRANGEMENTS

(71) Applicant: Scored Technologies Inc., Newcastle, DE (US)

(72) Inventors: Luke DZIERZEK, London (GB); Dimitrios KYRIAKOUDIS, London (GB); Simon WARDE, London (GB); lan FISHER, London (GB)

(21) Appl. No.: 18/258,165

(22) PCT Filed: Dec. 16, 2021
(86) PCT No.: PCT/US2021/072973

§ 371 Date: Jun. 16, 2023

(30) Foreign Application Priority Data
Dec. 18, 2020 (GB) 2020127.3

(51) Int. Cl. G11B 27/031

(52) U.S. Cl. CPC G11B 27/031

(57) ABSTRACT

A request for an audio arrangement having one or more target audio arrangement characteristics is received. One or more target audio attributes are identified based on the one or more target audio arrangement characteristics. First audio data is selected. The first audio data has a first set of audio attributes, which comprises at least some of the identified one or more target audio attributes. Second audio data is selected. The second audio data has a second set of audio attributes, which comprises at least some of the identified one or more target audio attributes. One or more mixed audio arrangements are output and/or data useable to generate the one or more mixed audio arrangements is output. The one or more mixed audio arrangements are generated by at least the selected first and second audio data being mixed using an automated audio mixing procedure.

### CROSS-REFERENCE TO RELATED APPLICATIONS

This application claims priority to UK Application No. GB2020127.3, filed Dec. 18, 2020, the entire contents of which are incorporated herein by reference.

### INTRODUCTION

### Field

The present disclosure relates to generating audio arrangements. Various measures (for example methods, systems and computer programs) of, and for use in, generating audio arrangements are provided. In particular, but not exclusively, the present disclosure relates to generative music composition and rendering audio.

### BACKGROUND

All audio files, such as music, are static streams of data. In particular, once music has been recorded, mixed, and rendered, the music cannot be varied dynamically, interacted with in real time, reused, or personalized in another form or context, in any meaningful way unless by an expert with the appropriate tools. Such music can therefore be considered to be ‘static’. Static music cannot power the world of interactive and immersive technologies and experiences. Most existing systems do not readily facilitate control and personalization of music.

US-A1-2010/0050854 relates to automatic or semi-automatic composition of a multimedia sequence. Each track has a predetermined number of variations. Compositions are generated randomly. The interested reader is also referred to US-A1-2018/076913, WO-A1-2017/068032 and US20190164528.

### SUMMARY

According to first embodiments, there is provided a method for use in generating an audio arrangement, the method comprising: receiving a request for an audio arrangement having one or more target audio arrangement characteristics; identifying one or more target audio attributes based on the one or more target audio arrangement characteristics; selecting first audio data, the first audio data having a first set of audio attributes, the first set of audio attributes comprising at least some of the identified one or more target audio attributes; selecting second audio data, the second audio data having a second set of audio attributes, the second set of audio attributes comprising at least some of the identified one or more target audio attributes; and outputting: one or more mixed audio arrangement, the one or more mixed audio arrangements having been generated by at least the selected first and second audio data having been mixed using an automated audio mixing procedure; and/or data useable to generate the one or more mixed audio arrangements.

According to second embodiments, there is provided a method for use in generating an audio arrangement, the method comprising: selecting a template to define permissible audio data for a mixed audio arrangement, the permissible audio data having a set of one or more target audio attributes compatible with the mixed audio arrangement; selecting first audio data, the first audio data having a first set of audio attributes, the first set of audio attributes comprising at least some of the identified one or more target audio attributes; selecting second audio data, the second audio data having a second set of audio attributes, the second set of audio attributes comprising at least some of the identified one or more target audio attributes; generating one or more mixed audio arrangements and/or data useable to generate the one or more mixed audio arrangements, the one or more mixed audio arrangements being generated by mixing the selected first and second audio data using an automated audio mixing procedure; and outputting said one or more generated mixed audio arrangements and/or data useable to generate the one or more mixed audio arrangements.

According to third embodiments, there is provided a method for use in generating an audio arrangement, the method comprising: analyzing video data and/or given audio data; identifying one or more target audio arrangement intensities based on the analysis of the video data and/or the given audio data; identifying one or more target audio attributes based on the one or more target audio arrangement intensities; selecting first audio data, the first audio data having a first set of audio attributes, the first set of audio attributes comprising at least some of the identified one or more target audio attributes; selecting second audio data, the second audio data having a second set of audio attributes, the second set of audio attributes comprising at least some of the identified one or more target audio attributes; and generating one or more mixed audio arrangements and/or data useable to generate the one or more mixed audio arrangements, the one or more mixed audio arrangements being generated by mixing the selected first and second audio data; and outputting said one or more generated mixed audio arrangements and/or data useable to generate the one or more mixed audio arrangements.

According to fourth embodiments, there is provided a system configured to perform a method according to any of the first through third embodiments.

According to fifth embodiments, there is provided a computer program arranged, when executed, to perform a method according to any of the first through third embodiments.

### BRIEF DESCRIPTION OF THE DRAWINGS

Various embodiments will now be described, by way of example only, with reference to the accompanying drawings in which:

FIG. 1 shows a block diagram of an example of a system in which an audio arrangement may be rendered;

FIG. 2 shows a flowchart of an example of a method of asset creation;

FIG. 3 shows a flowchart of an example of a method of handling a variation request;

FIG. 4 shows a representation of an example of a user interface (UI);

FIG. 5 shows a representation of an example of different audio arrangements;

FIG. 6 shows a representation of another example of a UI;

FIG. 7 shows a representation of another example of a UI;

FIG. 8 shows a representation of another example of a UI;

FIG. 9 shows a representation of another example of a UI;

FIG. 10 shows a representation of an example of a characteristic curve;

FIG. 11 shows a representation of another example of a characteristic curve;

FIG. 12 shows a graph of an example of an intensity plot; and

FIG. 13 shows a representation of another example of a UI.

### DETAILED DESCRIPTION

Most existing music delivery systems provide no, or limited, control over reusability of static music and audio content. For example, a musician may record a song and have no, or limited, control over how elements of that song are used and reused. Music content creators cannot easily contribute subsets of a track for use or reuse, as there is no infrastructure in place to receive, analyses, and automatically match them with other compatible assets and produce a full track upon request. Most existing systems do not allow any attributes, such as length, genre, musical structure, instrumentation, expression curves or other aspects of music to be changed after the music has been recorded. Such recorded music cannot therefore be easily, or at all, adapted to fit the requirements of various use-cases and media. Some existing artificial intelligence (AI)-based music composition and generation systems provide results of unsatisfactory quality. Since human musical creativity and expressivity in instrumental performance are particularly hard to model computationally, the resulting music suffers not only from generic-sounding composition but also from poor sound design and unrealistic, almost robotic, performances. In some existing systems, end users generally either pay a creator to compose bespoke music for the given content (i.e. video or games), or buy pre-made music which then needs to be cut and pasted together to fit other media or become the basis around which they will be created. Existing systems do not provide a middle-ground between these extremes. Existing systems have licensing complications around existing musical content being reused, for example on YouTube™, Twitch™, etc. Although, in principle, an end user could use a Digital Audio Workstation (DAW) to manipulate and/or personalize music created by another creator (albeit with severe limitations), a novice user who is merely looking for personalized music, may not be able to use existing music editing technology in an effective way. In addition, while editing a music project, such as a DAW project file, may give a recipient content to be manipulated, these project files, or individually rendered music stems, are rarely made accessible to end users. Such project files are also typically very large files and generally require paid-for software, and usually a series of paid-for plugins, in order to recover, reproduce, and modify the music resulting from the original project file. Such software generally presents complex user interfaces designed for expert music producers and may not be suitable for, or may at least have significantly limited functionality on, a smartphone or tablet device. End users may, however, wish to use such a device to generate large amounts of personalized music, substantially in real time, with an intuitive and efficient UI.

Compared, for example, to US-A1-2010/0050854, the present disclosure provides a system which enables structural changes and/or changes to sections. Such changes may be temporal (e.g. lengthening, rearranging, or shortening the composition), in the number and/or types of stems (e.g. adding or removing instruments and layers), or in the contents of individual stems (e.g. changing the sound or playing style of a guitar stem). The present disclosure also enables fewer musical limitations to be imposed in the process of generating an audio arrangement. In addition, the present disclosure enables composition generation to be controlled by an end user via a simplified and high-level brief. Such an end user may be a novice user. The UI provided in accordance with examples described herein enables a user to obtain highly personalized content, but with significantly reduced user expertise and interaction than would be necessary using existing audio editing software.

The present disclosure provides, amongst other things, an audio format, platform and variation system. Methods and techniques are provided for generating near-infinite music. The music may have various lengths, styles, genres, and/or perceived musical intensities. An end user may near-instantaneously cycle through significant numbers of different variations of a given track. Examples enable this through mixing and arranging purpose-composed, structured and semantically annotated audio files. The audio format described herein defines the way the audio is to be packaged, either by a human or through automated processing, in order for the system of the present disclosure to be able to use it.

The example audio platform and variation system described herein provides multiple features which are especially effective for end-users. Large amounts of high-quality content may be generated quickly and easily. End-users additionally have a significant degree of control over such content. Musical compatibility between assets is, in effect, guaranteed, with musicality being hand-crafted by expert music creators, during both the composition and recording stages. Intensity curves may be drawn and modified, either manually or automatically. The intensity curves can dynamically change and modify the audio. This may occur in real time. Human-written, case-specific rules regarding use and re-use of assets can be provided to ensure a musically pleasant end-result. For example, a creator may specify how music they record should and should not be automatically used and combined with music from other creators. Seamless loops and transitions between audio segments can be attained. This is achieved by having, in addition to the core audio, separate lead-in, lead-out and/or tail audio (also referred to herein as “audio tail”) segments for each audio asset. Lead-in segments constitute any and all audio that may be, or may be required to be, played in anticipation of the main content's appearance on the musical beat grid, such as a singer drawing a breath before starting to sing or a guitarist's accidental touches on the strings in anticipation of a new passage. An example of an audio tail is a reverb tail. Other example audio tails include, but are not limited to, delay tails, natural cymbal decay, etc. The content of these lead-in and tail segments may therefore differ according to the type of instruments or content they accompany, and can vary from fade-ins and swells to reverb tails and other long decays respectively. When any two audio blocks are temporally adjacent, the first block's tail is mixed in with the second block's beginning, while the second block's lead-in is mixed into the first block's ending. Compared to other methods, this creates a natural and smoother transition between blocks of audio, enabling the seamless looping and dynamic transitions between sections within a song with the proper overlapping of lead-in and tail-end audio. In addition, by keeping these lead-in and tail segment separate from the main segment, this method fully solves a problem which arises when attempting to isolate and use a subset of an audio recording; the immediately preceding audio's tail is “baked into” the current segment's beginning with no way of removing it, while its lead-in has been lost in the preceding segment's ending with no way of isolating it.

The example audio platform and variation system described herein also provides multiple features which are especially effective for creators. Creators can create what they feel comfortable with. Creators can produce an entire song, or any isolated part or stem to be used within a piece; whether the rest of that piece has already been created or not is irrelevant. As long as creators comply with a template, the example audio format, platform, and variation system enable audio stems to be mixed together in a structured and automated manner. The creator does not have to create large amounts of content for different uses; instead, the creator may record one or more parts, which may then be used as a basis for a significant number of highly customized tracks. Multiple creators may submit their work to be used and combined with that of other creators, producing previously unheard pieces of music. The only requirements for guaranteeing the compatibility of assets are that they all adhere to the same template and that their combination is in agreement with both the template-specific and the asset-specific rules.

In addition, natural musical understanding has been developed into a number of different UIs. This allows smooth transitions between different musical concepts and characteristics. For example, music may smoothly transition from “Electronic” to “Acoustic” and/or from “Relaxed” to “Energetic”. Other transitions may occur, such as towards a particular music creator and/or a combination of multiple music creators. Such Us may also be used within the contexts of virtual reality (VR), augmented reality (AR), 2D and 3D interactive environments, video games and others. Users may assume control of the high-level parameters exposed by the expert music creators using their input, for instance by moving, walking, navigating and interacting with those environments.

In addition to being usable for music, examples described herein can also be used in a similar manner for the use of vocal tracks, sound effects (SFX), ambient sound and/or noise, and/or other non-music use cases. For example, in relation to vocals, singers may be able to use the system described herein to sing over and change their vocals on-the-fly, for example male to female, different singing styles (such as rap, opera, jazz, pop, etc.). Singers can use the system to help accompany and inspire their rapping/singing by creating instant unique customizable backing tracks, on the fly, like an instant music producer. They are able to then create a completely unique and likely previously-unheard track. End users or listeners of the system can then benefit from multiple endless vocal options.

Examples described herein not only offer creators the ability to have their content reused in different contexts than the originally intended one (and control over how that reuse happens), but also allow them control over how elements of their music will be used within their original context initially.

An explanation of various terms used herein will now be provided, by way of example only.

The term “section” is generally used herein to mean a distinct musical section of a track. Examples of sections include, but are not limited to, Intro, Chorus, Verse and Outro. Each section may have a different length. The length may be measured in bars.

The term “section segment” or “segment” is generally used herein to mean one of the parts that a section is split into at the discretion of the creator, if any. Segments are used to make different-length variations of a single section possible. For example, some segments may be looped or skipped entirely to achieve the desired length or effect, e.g. lengthening a Chorus or shortening a Verse. In examples, each segment comprises or consists of a lead-in piece of audio, the core audio, and a tail-end piece of audio which may serve as a reverb tail or otherwise.

The term “stem” is generally used herein to mean a named plurality of audio tracks submitted by a creator. The tracks could be mono, stereo or any number of channels. A stem contains a single instrument or a plurality of instruments. For example, a stem may contain a violin, or an entire violin or string ensemble, or any other combination of instruments deemed by the creator to form an instrumental unit. Each stem may have one or more sections. In examples, each section is included, in order, in the same audio file as each other by the creator. The audio file may be a WAV file or otherwise. An audio file with multiple sections may later be sliced and stored in separate files, either manually or through an automated process. Compressed audio formats may be used to reduce requirements for asset storage, streaming, or downloading.

As indicated above, a track can, theoretically, be any number of channels. However, there may be compatibility issues between stems of different channel counts. Examples described herein provide mechanisms to address this. Such mechanisms enable the systems described herein to be used with, and/or be compatible inside, virtual words and/or gaming engines. In terms of compatibility between assets, a two-channel stem may be mixed with a six-channel stem, for example. The six-channel stem may be mixed down to a two-channel stem, or the two-channel stem may be automatically distributed or upscaled to a six-channel stem. The example engine described herein can work with any arbitrary number of channels. However, the number of channels may be relevant to building asset libraries for specific use-cases. In addition, multi-channel audio may not require multi-channel assets. For example, a mono recording of a guitar or bass can be panned anywhere in an eight-channel surround sound setting.

The term “stem fragment” is generally used herein to mean one of the audio parts into which a section segment of a stem is split. Examples of such sections include, but are not limited to, a lead-in, a main part, and a tail-end. Each stem fragment has a particular utility role and, in examples, can be one of: lead-in, main part, or tail-end. Each segment has these stem fragments, unless otherwise specified by the creator.

The term “part” is generally used herein to mean a group of stems that combine together to play a specific role in a track. For example, the stems may combine together as Melody, Harmony, Rhythm, Transitions etc. Parts can span over any number of sections of a track; from one section to the entire track.

The term “template” is generally used herein to mean a high-level outline of a musical structure. The template may dictate the temporal, structural, harmonic, and other elements of a high-level musical structure. The temporal elements may include the musical tempo, measured in beats per minute, the musical metre, measured in beats per bar, and any changes that may occur to those at any point in the musical structure. The structural elements may include the number and types of parts, the number and types of sections, their durations, their functional role in the musical structure, and other aspects relating to the high-level musical structure. The harmonic elements may include the musical key(s) and chord progression(s) for each section, specified as a harmonic timeline. The template may also control one or more further aspects of the music. The template may also include rules as to how any of the above elements may be used and reused. For example, the template may specify the permitted and not permitted combinations of parts, the permitted and not permitted sequences of sections, or other rules about the way stems should be composed, produced, mixed, or mastered. Overall, the template effectively guarantees the musical compatibility of all assets that adhere to its rules, as well as the musical soundness of all permitted combinations of those assets.

The term “template info” or “template information” is generally used herein to mean the set of data which defines the template and contains relevant metadata. The data may have many forms, such as a structured text file, a visual representation, a DAW project file, an interactive software application, a website and others. The template info may also contain a series of rules about how its various parts and stems can and cannot be combined in different ways and its sections sequenced. These rules may be created globally, being applied to the overall structure of the piece, or may be defined for specific parts, stems, or sections, at the discretion of creators. These rules may be specified by the original creator of the template and may be amended at a later date, either automatically or manually by the same or another creator.

The term “brief” is generally used herein to mean a set of user-specified characteristics that the resulting musical or audio output must satisfy. The brief is what informs the system of the end-user's needs.

The term “arrangement” is generally used herein to mean a curated subset of permissible stems and sections that belong to the same template; that is, of the many possible permitted sequences of sections, each containing one of the many possible permitted combinations of parts, each containing one of the many possible permitted combinations of stems. Different arrangements can contain different melodies, different instrumentation, belong to different musical genres, invoke different emotions to the listener, have a different perceived musical intensity, and/or have different lengths.

The term “mix” is generally used herein to mean a mixed-down audio file, with any number of channels, which comes as a result of mixing together the plurality of audio files which constitute an arrangement.

The term “composer” is generally used herein to mean a creator, which is anyone that uses the platform described herein and/or creates content for the platform. Examples include, but are not limited to, musicians, vocalists, remixers, music producers, mixing engineers etc.

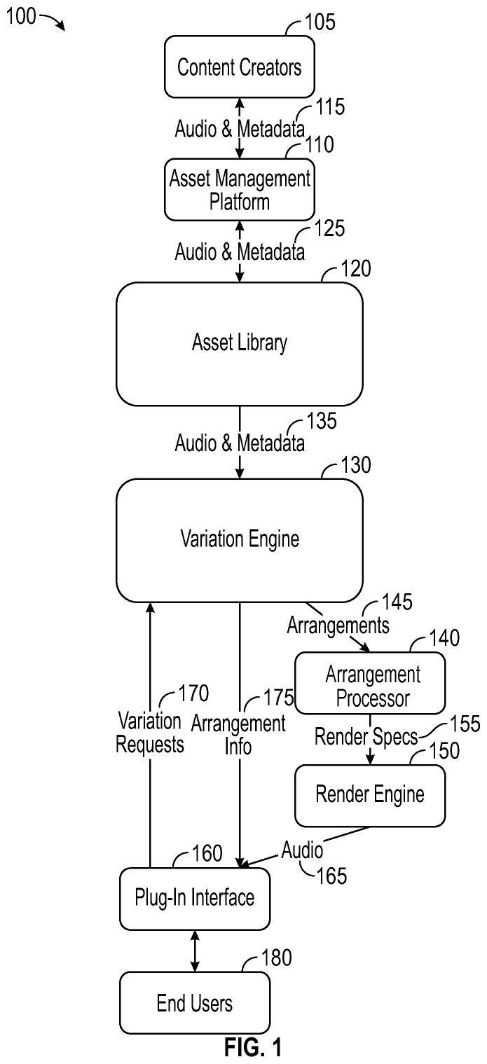

Referring to FIG. 1, there is shown an example of a system 100. The system 100 may be considered to be an audio platform and variation system. An overview of the system 100 will now be provided, by way of example only.

In this example, the system 100 comprises one or more content creators 105. In practice, the system 100 comprises a large number of different content creators 105. Each content creator 105 may have their own audio recording and production equipment, follow their own creative workflows, and produce wildly different-sounding content. Such audio recording and production equipment may involve different music production systems, audio editing tools, plugins and the like.

In this example, the system 100 comprises an asset management platform 110. In this example, the content creator(s) 105 exchange data bidirectionally 115 with the asset management platform 110. In this example, the data 115 comprises audio and metadata. The data 115 may comprise video data.

In this example, the system 100 comprises an asset library 120. In this example, the asset management platform 110 exchanges data bidirectionally 125 with the asset library 120. In this example, the data 125 comprises audio and metadata. The asset library 120 may store audio data in conjunction with a set of audio attributes of the audio data. The audio attributes may be specified by the creators or other humans, and/or may be automatically extracted through Digital Signal Processing (DSP) and Music Information Retrieval (MIR) means. The asset library 120 may, in effect, provide a database of audio data which can be queried using high and low-level audio attributes. For example, a search of the asset library 120 may be conducted for audio data having one or more given target audio attributes. Information on any audio data in the asset library 120 having the one or more given target audio attributes, and/or the matching audio data itself, may be returned. The asset library 120 may comprise video data.

In this example, the system 100 comprises a variation engine 130. In this example, the variation engine 130 receives data 135 from the asset library 120. In this example, the data 135 comprises audio and metadata. The data 135 may comprise video data in some examples.

In this example, the system 100 comprises an arrangement processor 140. In this example, the arrangement processor 140 receives data 145 from the variation engine 130. In this example, the data 145 comprises arrangements (which may also be referred to herein as “arrangement data”).

In this example, the system 100 comprises a render engine 150. In this example, the render engine 150 receives data 155 from the arrangement processor 140. In this example, the data 155 comprises render specifications (which may also be referred to herein as “render specification data”).

In this example, the system 100 comprises a plug-in interface 160. In this example, the plug-in interface 160 receives data 165 from the render engine 150. In this example, the data 165 comprises audio (which may also be referred to herein as “audio data”). The data 165 may comprise video in some examples.

In this example, the plug-in interface 160 provides data 170 to the variation engine 130. In this example, the data 170 comprises variation requests (which may also be referred to herein as “variation request data”, “request data” or “requests”).

In this example, the plug-in interface 160 receives data 175 from the variation engine 130. In this example, the data 175 comprises arrangement information. The purpose of this data is the visualization or other form of communication of the arrangement information to the end user.

In this example, the system 100 comprises one or more end users 180. In practice, the system 100 comprises a large number of different end users 180. Each end user 180 may have their own user device(s).

Although the system 100 shown in FIG. 1 has various components, the system 100 can comprise different components in other examples. In particular, the system 100 may have a different number and/or type of components. Functionality of components of the system 100 may be combined and/or divided in other examples.

The example components of the example system 100 may be communicatively coupled in various different ways. For example, some or all of the components may be communicatively coupled via one or more data communication networks. An example of a data communication network is the Internet. Other types of communicative coupling may be used. For example, some of the communicative couplings may be logical couplings between different logical components of the same hardware and/or software entity.

Components of the system 100 may comprise one or more processors and one or more memories. The one or more memories may store computer-readable instructions which, when executed by the one or more processors, cause methods and/or techniques described herein to be performed.

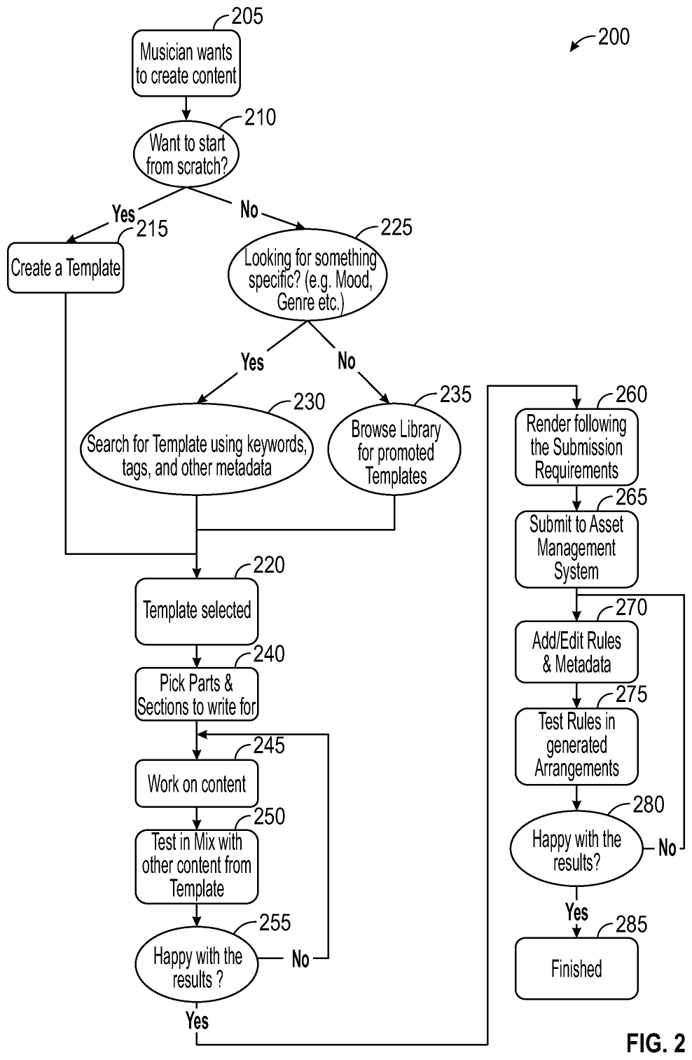

Referring to FIG. 2, there is shown a flowchart illustrating an example of a method 200 of asset creation. Asset creation may be performed in a different manner in other examples.

At item 205, a musician wants to create content.

At item 210, it is determined whether the musician wants to start content creation from scratch, without a template, or use a template as an existing creative framework.

If the result of the determination of item 210 is that the musician wants to start from scratch, a template is created at item 215. As a result, at item 220, a template has been selected.

If the result of the determination of item 210 is that the musician does not want to start from scratch, it is determined, at item 225, whether the musician already has an idea of the type of music they would like to create. For example, the musician may be looking for a template with a particular tempo, metre, or to create for a particular mood, genre, use-case etc.

If the result of the determination of item 225 is that the musician is looking for a specific template, then, at item 230, a search is conducted for a template. Such a search may use keywords, tags and/or other metadata. As a result of the search, at item 220, a template is selected.

If the result of the determination of item 225 is that the musician is not looking for a specific template, then, at item 235, the musician browses a library for promoted templates. As a result of the browsing, at item 220, a template is selected.

Following the selection of the template at item 220, the musician, at item 240, decides and selects the parts and sections to write content for.

At item 245, the musician then works on and records such content.

At item 250, the musician then tests the content in a mix with other content from the selected template. For example, the musician and/or another musician may already have recorded content in the selected template. The musician can assess how the new content sounds in the mix with the existing content.

At item 255, it is determined whether the musician is happy with the results of item 250.

If the result of the determination of item 255 is that the musician is not happy with the results of item 250, then the musician returns to working on the content at item 245 and tests new content in the mix with other content from the template at item 250.

If the result of the determination of item 255 is that the musician is happy with the results of item 250, then, at item 260, the content is rendered. The content is rendered to follow given submission requirements. Such requirements may, for example, relate to naming conventions, structuring the audio in and around sections, including lead-in and/or tail-end audio

At item 265, the rendered content is then submitted to an asset management system, such as the asset management platform 110 described above with reference to FIG. 1.

At item 270, the musician then adds and/or edits rules and/or metadata. The rules may relate to how the content can and cannot be used in conjunction with other content or in particular contexts. The metadata may provide musical attribute information associated with the content. Such metadata may indicate, for example, the instrument(s) used to create the content, the genre of the content, the mood of the content, the musical intensity of the content etc.

At item 275, the musician then tests the rules in generated arrangements. For example, the musician may have specified, via a rule, which the content should not be mixed with content having a specified musical attribute.

At item 280, it is determined whether the musician is happy with the results of item 275.

If the result of the determination of item 280 is that the musician is not happy with the results of item 275, then the musician returns to adding and/or editing the rules and/or metadata at item 270 and testing the rules in generated arrangements at item 275.

If the result of the determination of item 280 is that the musician is happy with the results of item 275, then, at item 285, asset creation is finished.

In an example, the musician uses a web browser for the above items other than the creation and export of audio. Searching for and creating templates, selecting parts and sections, testing the content with other content, specifying rules and other metadata, etc. all happen through a browser interface. This provides a relatively simple form.

However, a more user-friendly, but more technically complex, form is also provided. In this example, the musician performs all actions in the DAW. They interact with the asset management system and library described herein through the use of multiple instances of a Virtual Studio Technology (VST) plugin, to enable compatibility with any and all platforms that support the VST standard. The user then interacts with the instances of that VST plugin (either with the “master” instance or with track-specific instances) to specify and submit all of the aforementioned data.

As such, creating assets may involve the following main human loop. Firstly, the creator picks an existing template, or creates a new template. The creator then decides which part(s) to create content for and/or instruments etc. The creator then decides sections to write each part for. The creator then writes the music. The creator then exports the music using a standardized format. The standardized format may comprise standardized naming schemes, gaps in sections, lead-ins, reverb tails etc. The creator then specifies metadata relating to the stems. The metadata may be specified in an information file, via a web app, or in another manner. The creator then submits the result to a central catalogue.

Assets created by the creator may be digested using the following one-off routine. Firstly, automated normalization and/or mastering may be performed on the content provided by the creator. Then, DSP may be applied on the assets for the purpose of audio and musical feature extraction. Then, assets may be split into their containing sections, sub-sections, and fragments. Then, the fragments may be added to the configuration of the selected template and stored with other relevant and functionally similar assets.

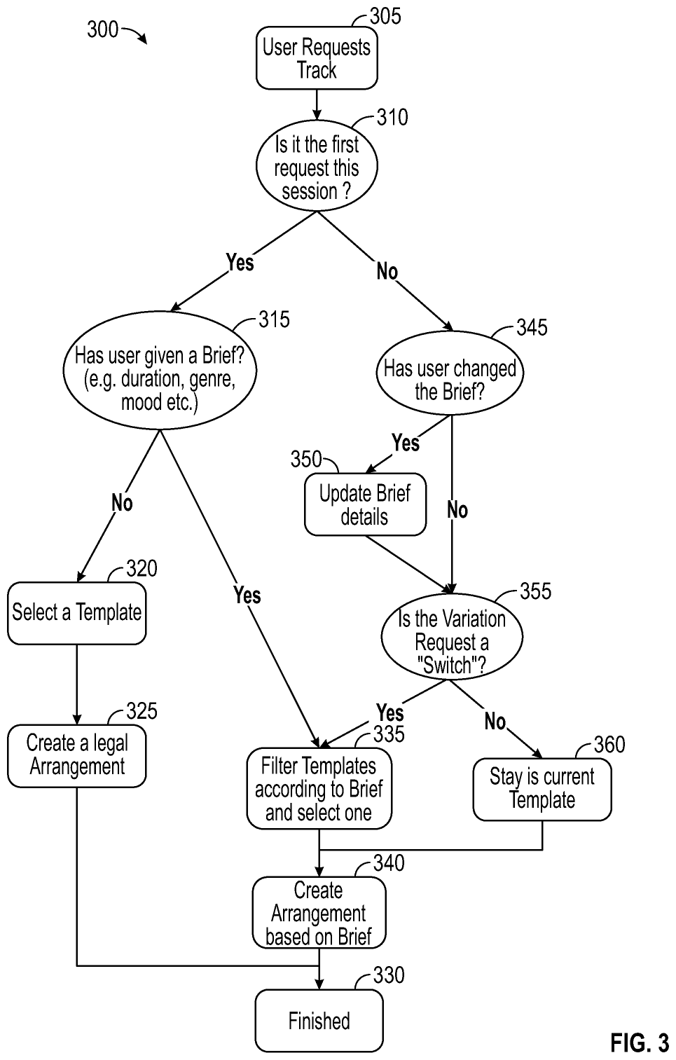

Referring to FIG. 3, there is shown a flowchart illustrating an example of a method 300 of handling a variation request (which may also be referred to herein as “processing” a variation request). Variation request handling may be performed in a different manner in other examples.

At item 305, a user requests a track. This corresponds to the user issuing a variation request.

At item 310, it is determined whether this is the first request of this session.

If the result of the determination of item 310 is that this is the first request of this session, then, at item 315, it is determined whether the user has given a brief. The brief may specify a musical characteristic of the track. Examples of such musical characteristics include, but are not limited to, duration, genre, mood and intensity. Although this is the first request of this session and is not varying an earlier request, it is nevertheless requesting a variation (which may also be referred to herein as a “variant”) of the track. A musical characteristic is a type of target audio arrangement characteristic. Target audio arrangement characteristics are different from target audio attributes. In examples, target audio attributes are low-level attributes of the piece of music, whereas target audio arrangement characteristics represent high-level characteristics.

If the result of the determination of item 315 is that the user has not provided a brief, then, at item 320, a template is selected.

At item 325, a permitted arrangement (in other words, an arrangement that meets predetermined requirements in satisfying a template's rules) is then created. A permitted template may also be referred to herein as a “legal” template.

At item 330, the variation request is then finished.

If the result of the determination of item 315 is that the user has given a brief, then, at item 335, the templates are filtered according to the brief and one template is selected.

At item 340, an arrangement is then created based on the brief and variation request handling proceeds to item 330, where the variation request is finished.

If the result of the determination of item 310 is that this is not the first request of this session, then, at item 345, it is determined whether the user has changed the brief.

If the result of the determination of item 345 is that the user has changed the brief, then, at item 350, the brief details are updated.

Then, at item 355, it is determined whether the variation request is a “Switch”.

If the result of the determination of item 355 is that the variation request is a “Switch”, then variation request handling proceeds to 335.

If the result of the determination of item 355 is that the variation request is not a “Switch”, then, at item 360, the current template is used, and the variation request handling proceeds to item 340.

If the result of the determination of item 345 is that the user has not changed the brief, then item 350 is bypassed, and the variation request handling proceeds to item 355.

As such arrangement creation may involve the following main part system loop. If starting from scratch, a permitted arrangement is created using the request brief (if any) and the rules of the template. Otherwise, a variation of the current arrangement is created based on the variation request brief and the rules of the template.

Various techniques and approaches may be used for creating arrangements. Human-specified, pre-set arrangements may be used. A random selection of content variations may be used. Elements may be selected based on tags and/or genres. Generation of an arrangement may be motivated by automated intelligent technologies for audio, video, text or other medium analysis. For example, video may be analyzed to extract semantic content descriptors, optical flow, color histograms, scene cut detection, speech detection, perceived intensity curve and/or others, and an arrangement may be generated to match the video. Selection and generation of arrangements may be AI-based. An arrangement may be modified pseudo-randomly. For example, the arrangement may be modified by a “Tweak”, “Vary”, “Switch” or other modification. Assets are tagged with two types of relative “weight” coefficients: musical weight and spectral weight. Musical weight refers to how much compositional “weight” is assigned to a particular stem, purely concerned with its symbolic composition. Musical weights are typically specified explicitly by creators, but may also be automatically deduced by analyzing Music Instrument Digital Interface (MIDI) data or through MIR methods. Spectral weights refer to how much “weight” a recording occupies on the frequency spectrum, as well as how that weight is distributed across the spectrum. Spectral weights are typically calculated automatically through MIR processes, but may also be explicitly specified or overwritten by creators. In all cases of weights being explicitly specified by creators, the resulting pair of MIR data and weight value is recorded and added to a dataset used for the continuous training and refinement of Machine Learning (ML) models making the automatic analyses. Both the musical and spectral weights coefficients may be used to inform stem selection for arrangements with specific target intensities, while spectral weight coefficients may also be used to inform the automated mixing and mastering processes.

An arrangement may be created based on an intensity parameter. The intensity parameter provides a single, user-side control that affects various factors in arrangement creation. One such factor is the selection of which stems to use. Such selection may use weight coefficients and balance their sum. Another such factor is the gain of each stem. The rules of a lead creator regarding part presence in each intensity layer may be used. Another such factor is the number of parts used and number of stems included within each arrangement. Arrangements may be generated via biological and/or environmental sensor input. Arrangements may be entirely automated, without user input or visual display. For example, a personalized, dynamic, and/or adaptive playlist may be generated, which can be shared by the user, listened to like a personal digital radio experience, and interacted with by other users to generate further arrangements.

Arrangements may be generated via selection of individual stems through semantic terms. Arrangements may be generated via voice commands to select appropriate stems or stem transitions. Stems may be added, removed, processed, or swapped with other compatible assets upon a user's request. For instance, the user may request that they want a saxophone melody instead of a guitar, or a female vocal instead of a male. In addition, they may request the processing of these stems with additional post-production effects, such as reverb or pitch shifting.

Arrangements may be generated through ML algorithms that analyses the user's past arrangements and preferences. Arrangements may also be generated by AI that analyses a user's listening habits, potentially using a user's listening history on services like Spotify™ or YouTube™ if requested. Arrangements may be generated by combining or unlocking compatible stems from within virtual world gameplay. Arrangements may be generated by uploading a reference audio file, video file or any type of media or data input and requesting a similar outcome. Arrangements may be generated and/or modified via a Scored Curve™. A Scored Curve™ is an automation graph which captures the parameter adjustments (such as intensity) on record as used herein. The node points and/or curves may be adjusted. The curve may be drawn rapidly to provide the basis for an arrangement. Arrangements may, however, be generated and/or modified in other ways.

Arrangements may be rendered in various ways. An arrangement may be rendered direct to an audio file. An arrangement may be streamed. An arrangement may be modified in real time and played back.

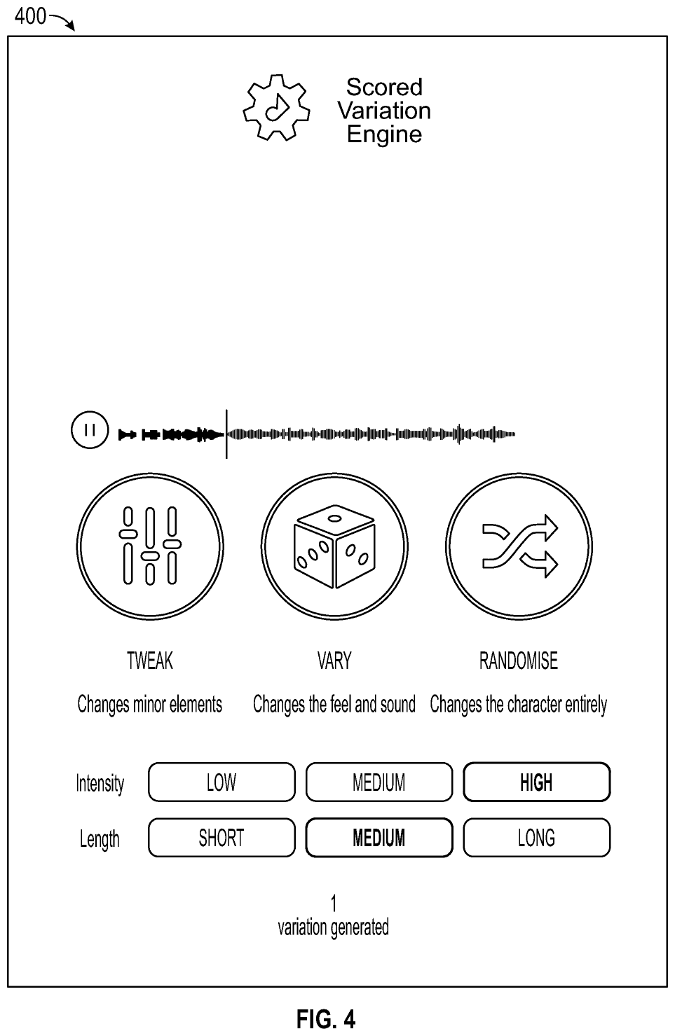

Referring to FIG. 4, there is shown an example of a UI 400. In this example, the UI 400 enables an end user to make variation requests.

In this example, the UI 400 comprises a play/pause button.

In this example, the UI 400 comprises a waveform representation of a track being played and playback progress through that track.

In this example, the UI 400 comprises a “Tweak” button. User-selection of the “Tweak” button requests and results in changes to minor elements of the track, but keeps the overall sound of the track the same.

In this example, the UI 400 comprises a “Vary” button. User-selection of the “Vary” button requests and results in changes to the feel and sound of the track. However, the track still retains the same overall structure.

In this example, the UI 400 comprises a “Randomize” button. User-selection of the “Randomize” button requests and results in entire changes to the character of the track in a non-deterministic manner.

In this example, the UI 400 comprises “low”, “medium” and “high” intensity buttons. User-selection of one of these buttons requests and results in changes to the intensity of the track.

In this example, the UI 400 comprises “short”, “medium” and “long” duration buttons. User-selection of one of these buttons requests and results in changes to the duration of the track.

In this example, the UI 400 also indicates the number of variations generated in the current session.

It can be seen that such a UI 400 is highly intuitive, which allows a significant number of variants of a track to be rendered with minimal user input.

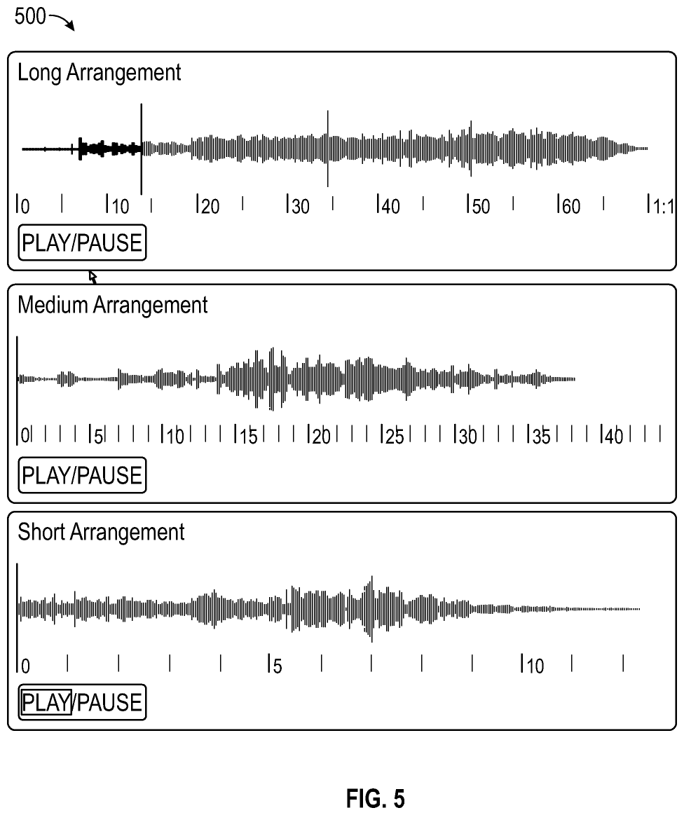

Referring to FIG. 5, there is shown different arrangement examples 500 of a given track.

These examples 500 demonstrate some of the versatility of the variation engine 130 described above with reference to FIG. 1.

All three examples 500 are curated from the same track, but the end results are drastically different. Structural variations allow tracks of different lengths to be created. Proprietary building blocks may be combined to match the length of media, such as video, audio or hybrid media formats, the music is synced to, if applicable. Variations, such as instrumentation, orchestration, mixing production and timbre, take place across each example to avoid repetition. An intensity engine creates real-time, dynamically controllable, natural progression through soft and climactic moments.

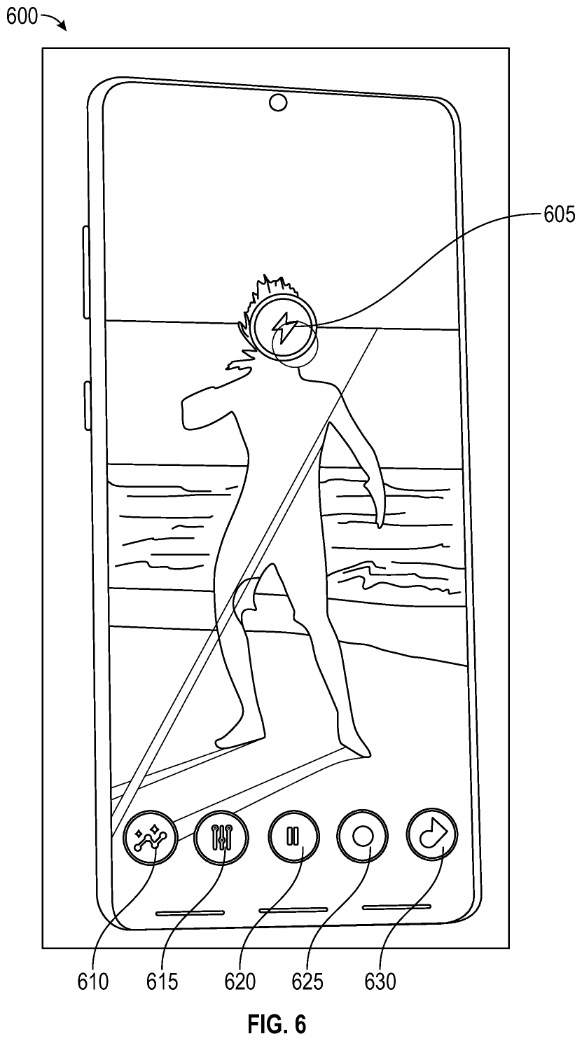

Referring to FIG. 6 there is shown another example of a UI 600.

In this example, the UI 600 comprises an intensity slider 605. By touching the intensity icon and sliding it up and down the screen, the user can control the intensity of the track. A visual representation of the intensity level is provided through the position of the icon and use of a filter or color variation on the video. The intensity may correspond to the energy and/or emotion of the track.

In this example, the UI 600 comprises an Autoscore™ button 610. Autoscore™ technology analyses video content and automatically creates a musical score to accompany it. Once created, the user may be able to adjust music textures of the musical score.

In this example, the UI 600 comprises a variation request button 615. As explained above, variation requests allow the user to swap dynamically between different moods, genres and/or themes. This allows the user to explore almost infinite combinations. Unique, personalized music can thereby be provided for different users.

In this example, the UI 600 comprises a playback control button 620. In this example, the playback control button 620 allows the user to toggle between playback and playback being paused.

In this example, the UI 600 comprises a record button 625. The record button 625 records the manual movement of intensity via the slider parameter or via sensors, etc. It can overwrite previous recordings. In this example, the UI 600 comprises a library button 630. The library button 630 allows a user to navigate, modify, interact with and/or hotswap the current music asset from the library of dynamic tracks and/or previews.

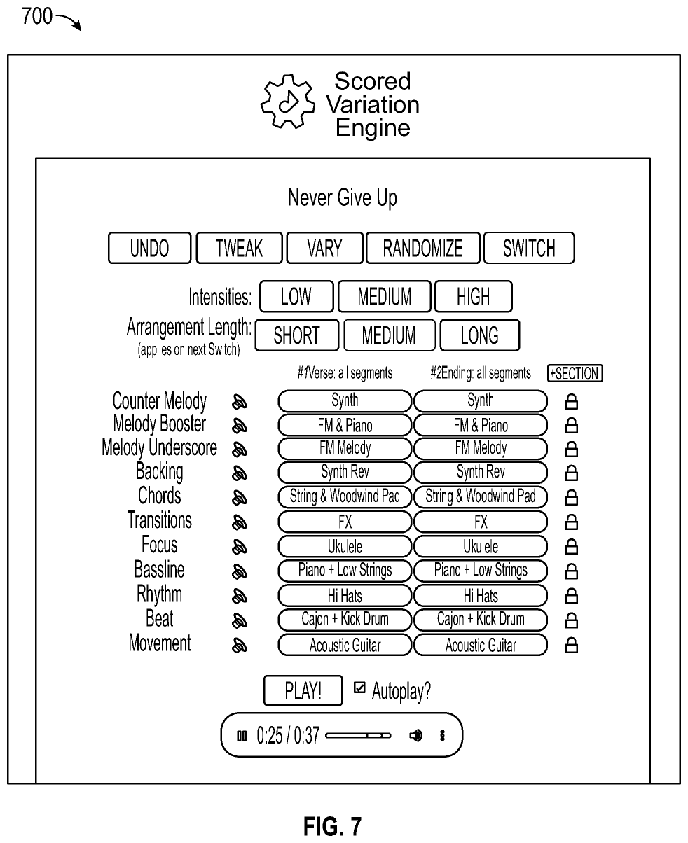

Referring to FIG. 7 there is shown another example of a UI 700. The example UI 700 represents a backend system.

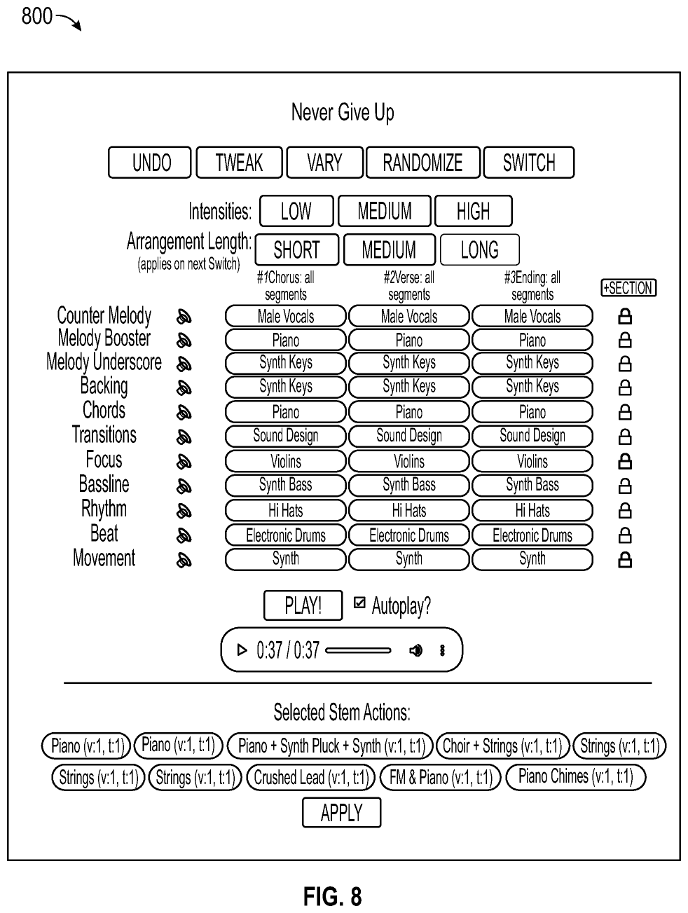

Referring to FIG. 8 there is shown another example of a UI 800. The example UI 800 represents stem selection.

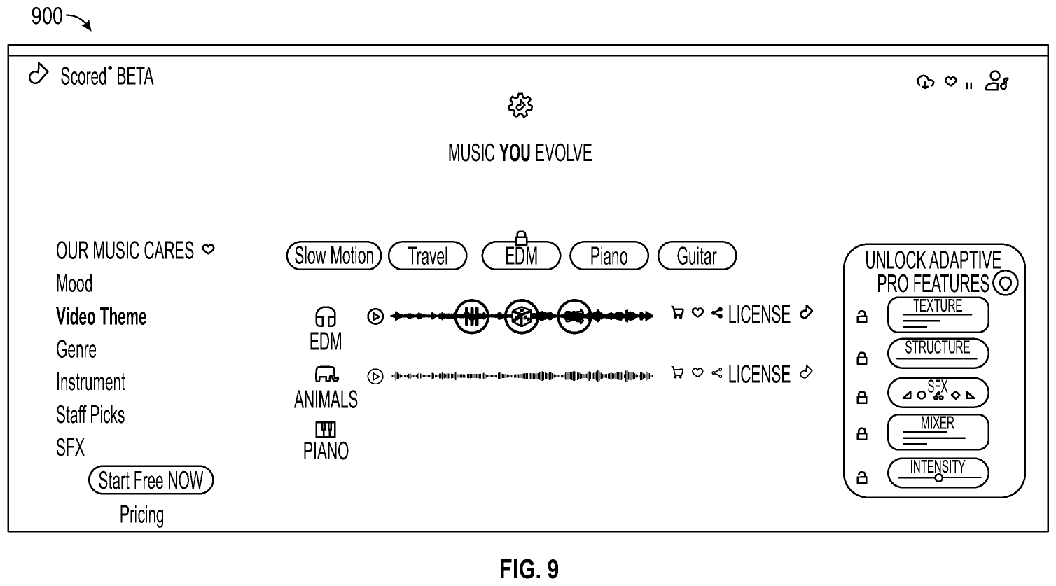

Referring to FIG. 9 there is shown another example of a UI 900. The example UI 800 represents a web-based interface for an example interactive music platform and/or system, such as described herein.

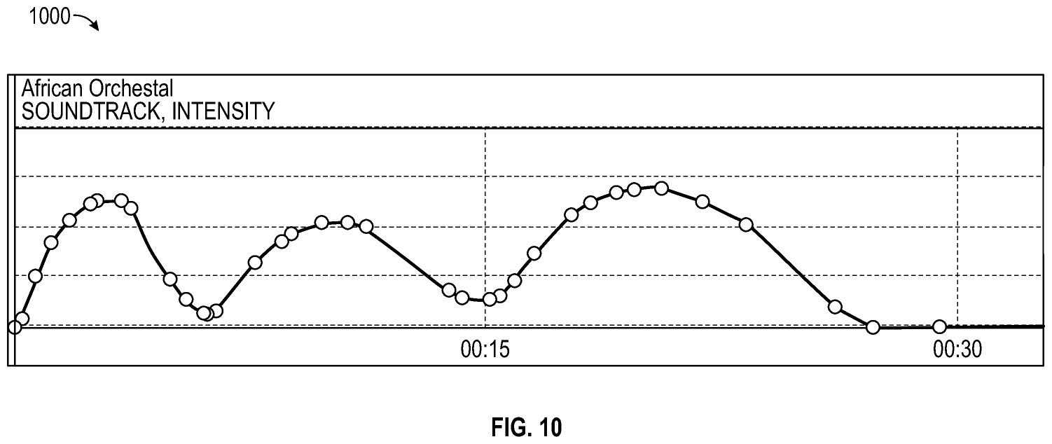

Referring to FIG. 10 there is shown an example of a characteristic curve 1000. The example characteristic curve 1000 shows an example of how intensity varies with time.

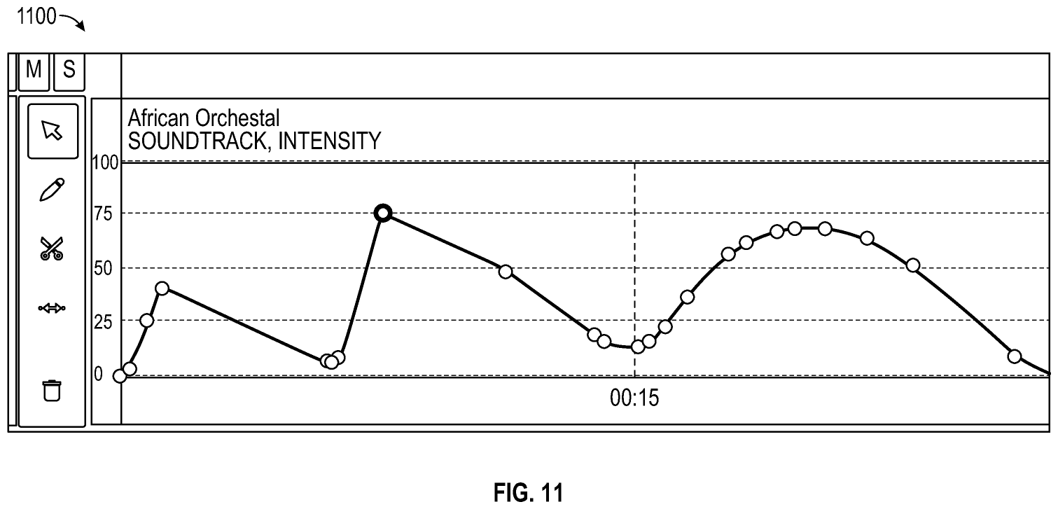

Referring to FIG. 11 there is shown another example of a characteristic curve 1100. The example characteristic curve 1100 shows an example of how intensity variation with time may be modified.

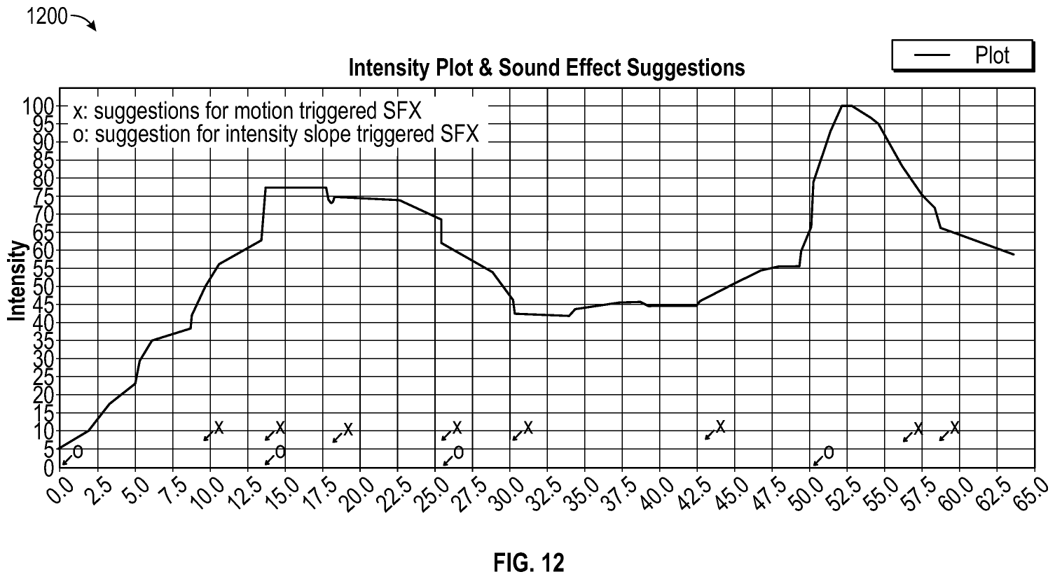

Referring to FIG. 12 there is shown an example of an intensity plot 1200. Suggestions for motion-triggered and intensity-triggered SFX are depicted. The intensity plot 1200 may be obtained by analyzing video data. A resulting audio arrangement may accompany the video data.

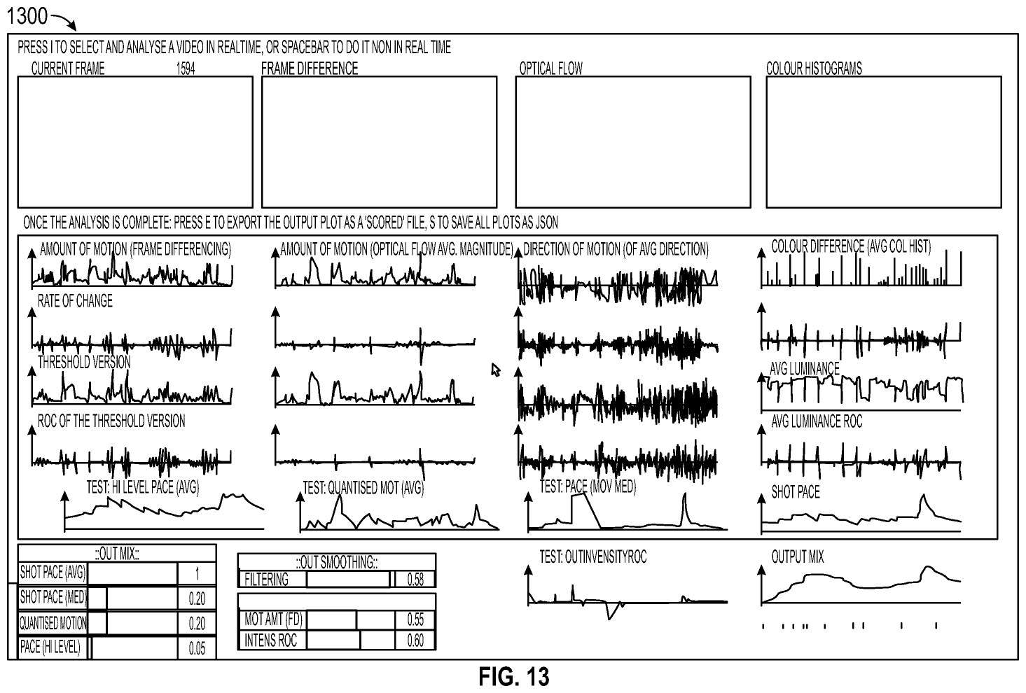

Referring to FIG. 13 there is shown another example of a UI 1300. The example UI 1300 depicts how a video can be selected and analyzed in real time or non-real time. Once analysis is completed, the resulting plot may be exported as a Scored™ file.

Various measures (for example, methods, systems and computer programs) are provided in relation to generating one or more audio arrangements. Such measures enable highly personalized audio arrangements to be generated efficiently and effectively. Such audio arrangements may be provided substantially in real time to an end user. The end user may be able to use a UI with relatively few options to select from to generate personalized audio arrangements. This differs significantly from, for example, a typical DAW, which a novice user is unlikely to be able to navigate quickly and efficiently.

A request is received for an audio arrangement having one or more target audio arrangement characteristics. The request may correspond to a variation request as described above. In particular, the variation request may be an initial request for an initial variant of an audio arrangement, or may be a subsequent request for a variation of an earlier variant of an audio arrangement. A target audio arrangement characteristic may be considered to be a desired characteristic of an audio arrangement. Examples of such characteristic include, but are not limited to, intensity, duration and genre.

One or more target audio attributes are identified based on the one or more target audio arrangement characteristics. A target audio attribute may be considered to be a desired attribute of audio data. An audio attribute may be more granular than an audio arrangement characteristic. An audio arrangement characteristic may be considered to be a high-level representation of the musical structure. For example, a desired audio arrangement characteristic may be medium intensity. One or more desired audio attributes may be derived from a medium intensity. For example, one or more spectral weight coefficients (an example of an audio attribute) may be identified as corresponding to a medium intensity.

First audio data is selected. The first audio data has a first set of audio attributes. The first set of audio attributes comprises at least some of the identified one or more target audio attributes. Second audio data is also selected. The second audio data has a second set of audio attributes. The second set of audio attributes comprises at least some of the identified one or more target audio attributes. Using the above example of a desired medium intensity for an audio arrangement, the one or more target audio attributes may include one or more desired spectral weight coefficients corresponding to a medium intensity. The first and second audio data may be selected based on them having the desired spectral weight coefficients. This may correspond to the first and second audio data having the exact spectral weight coefficient(s) sought, having spectral weight coefficients within a range of the spectral weight coefficient(s) sought, the spectral weight coefficient(s) sought being a given function (such as the sum) of the spectral weight coefficients of the first and second audio data, or otherwise. The first and second sets of audio attributes comprises at least some of the identified one or more target audio attributes. The first and second sets of audio attributes may not comprise all of the one or more target audio attributes. The first and second sets of audio attributes may comprise different ones of the one or more target audio attributes.

One or more mixed audio arrangements are output and/or data useable to generate the one or more mixed audio arrangement is output. The one or more mixed audio arrangements are generated by at least the selected first and second audio data being mixed using an automated audio mixing procedure. Further audio data may be mixed into the audio arrangement(s). The data useable to generate the mixed audio arrangement(s) if output may comprise the first and second audio data (and/or data to enable the first and second audio data to be obtained) and automated mixing instructions. The automated mixing instructions may comprise instructions for a recipient device on how the first and second audio data are to be mixed using the automated audio mixing procedure. The mixed audio arrangement(s) may be output in various different forms, such as an audio file, streamed, etc. Alternatively or additionally as indicated above, data useable to generate the mixed audio arrangement(s) may be output. The automated mixing may therefore be performed at a server and/or at a client device.

The method may comprise mixing the selected first audio data with the selected second audio data using the automated audio mixing procedure to generate the mixed audio arrangement(s). Alternatively, the mixing may be performed separately from the above method. The mixing may thereby be automated. Again, this enables a novice user to be able to control generation of a large number of variations of new audio content.

The one or more target audio arrangement characteristics may comprise target audio arrangement intensity. The inventors have identified intensity as a particularly effective audio arrangement characteristic in enabling a user to generate suitable audio content. Intensity may also be mapped to objective audio attributes of audio data to provide highly accurate results.

The target audio arrangement intensity may be modifiable after the one or more mixed audio arrangements have been generated. As such, intensity can still be modified and used to control the audio arrangement(s) dynamically, for example once the one or more audio arrangements have been mixed.

A first spectral weight coefficient of the first audio data may be calculated based on spectral analysis of the first audio data. A second spectral weight coefficient of the second audio data may be calculated based on spectral analysis of the second audio data. The first and second audio data may be mixed using the calculated first and second spectral weight coefficients and based on the target audio arrangement intensity. Again, such objective analysis of the audio data provides highly accurate results. A creator of the audio data may be able to indicate a spectral weight coefficient of the audio data they create, but this is likely to be more subjective.

The first set of audio attributes may comprise a first creator-specified spectral weight coefficient. The second set of audio attributes may comprise a second creator-specified spectral weight coefficient. The selecting of the first audio data and the selecting of the second audio data may be based on the first and second creator-specified spectral weight coefficients respectively. The creator may be able to guide the system of the present disclosure on determining spectral weight. The creator-specified spectral weight coefficient(s) may be used as a starting point or cross-check for analyzed spectral weight coefficients.

The one or more target audio arrangement characteristics may comprise target audio arrangement duration. This enables the end user to obtain a highly personalized audio arrangement. Again, a novice user is likely to find it difficult to use a DAW to create a track of a given duration. Examples described herein readily enable the end user to achieve this.

The first set of audio attributes may comprise a first duration of the first audio data. The second set of audio attributes may comprise a second duration of the second audio data. The selecting of the first audio data and the selecting of the second audio data may be based on the first and second durations respectively. As such, the system described herein may readily identify contender audio data that can be used to create the audio arrangement of the desired duration.

The one or more target audio arrangement characteristics may comprise genre, theme, style and/or mood.

A further request for a further audio arrangement having one or more further target audio arrangement characteristics may be received. One or more further target audio attributes may be identified based on the one or more further target audio arrangement characteristics. The first audio data may be selected. The first set of audio attributes may comprise at least some of the identified one or more further target audio attributes. Third audio data may be selected. The third audio data may have a third set of audio attributes. The third set of audio attributes may comprise at least some of the identified one or more further target audio attributes. A further mixed audio arrangement and/or data useable to generate the further mixed audio arrangement may be output. The further mixed audio arrangement may have been generated by at least the selected first and third audio data having been mixed using the automated audio mixing procedure. As such, the first audio data may be used in generating a further audio arrangement, but with third (different) audio data. This enables a large number of different variants to be readily generated.

The first and/or second audio data may be derived using an automated audio normalization procedure. This can provide a more balanced audio arrangement. This is especially, but not exclusively, effective where audio data is provided by different creators, each of which may record and/or export audio at different levels. The automated audio normalization procedure is also especially effective for novice users who may be unable to control levels of different audio data effectively.

The first and/or second audio data may be derived using an automated audio mixing procedure. The automated audio mixing procedure is also especially effective for novice users who may be unable to mix audio data effectively.

The first and/or second audio data may be derived using an automated audio mastering procedure. This can provide a more useable audio arrangement. Without such mastering, the audio arrangement may lack sonic qualities desired for public use of the audio arrangement.

The audio arrangement(s) may be mixed independent of any user input received after the selection of the first and second audio data. As such, fully automated mixing may be provided.

The first and/or second set of audio attributes may comprise at least one inhibited audio attribute. The at least one inhibited audio attribute may indicate an attribute of audio data which is not to be used with the first and/or second audio data. The selection of the first and/or second audio data may be based on the at least one inhibited audio attribute. A creator of the first and/or second audio data may thereby specify that the first and/or second audio data should not be used in an audio arrangement with audio data having a certain inhibited attribute. For example, a creator of a gentle, harp recording might specify that the recording must not or should not be used in an arrangement in the ‘rock’ genre.

Further audio data may be disregarded for selection for use in the audio arrangement based on the further audio data having at least some of the at least one inhibited audio attributes. Audio data that might, in a technical sense, be used in the audio arrangement can thereby be disregarded for the audio arrangement, for example based on creator-specified preferences.

The first and/or second audio data may comprise a lead-in, primary musical (and/or other audio) content and/or body, a lead-out, and/or an audio tail. The system of the present disclosure thereby has more control over the generation of the audio arrangement. Without such, the resulting audio arrangement may feel less natural. In addition, a creator may consider that a particular lead-in should always be used together with the main audio part they record.

Only a portion of the first and/or second audio data may be used in the audio arrangement. The system of the present disclosure may, for example, truncate a portion of the first and/or second audio based on a target duration of the audio arrangement. For example, if the first and/or second audio data is longer than the target duration of the audio arrangement, but is otherwise appropriate for inclusion in the audio arrangement, the system may truncate the first and/or second audio data to match the target duration.

The first audio data may originate from a first creator and the second audio data may originate from a second, different creator. As such a given audio arrangement, such as a song, may have elements from different creators who, for example, may record based on their individual expertise and/or preferences. Such creators may not have collaborated together, but may nevertheless have both of their content combined into a single audio arrangement.

The audio arrangement may be based further on video data (and/or given audio data). The audio arrangement may, for example, be matched in duration with the video data (and/or given audio data). A target audio arrangement characteristic may be derived from the video data (and/or given audio data).

The video data (and/or given audio data) may be analyzed. As such, an audio arrangement to accompany the video data (and/or given audio data) may be generated.

The one or more target audio arrangement characteristics may be based on the analysis of the video data (and/or given audio data). As such, automated audio generation to accompany the video data (and/or given audio data) may be provided.

Video data may be output to accompany the one or more mixed audio arrangements and/or the data useable to generate the one or more mixed audio arrangements. Benefits of outputting accompanying video data are twofold. First, this can help to better contextualize the audio arrangement(s) for the listener, providing a visual representation that can help to underscore the emotions or story being conveyed. Secondly, video data can also be used to generate the mixed audio arrangement(s), allowing for greater flexibility and control over the final product. The accompanying video can provide a more immersive experience for the viewer, as they can see and hear the audio arrangement being created in real time. Additionally, the video can be used to create a more engaging and visually appealing presentation, which can help to attract attention and encourage viewership. By being able to see the musicians, other performers, visual art, objects, the listener can better appreciate the music. Additionally, the video can be used to add visual elements that are not possible with just audio, such as scenery or special effects. The video can help to create a visual backdrop to the audio, adding an extra layer of dimension and excitement to the mix. Additionally, the video data can be used to generate the mixed audio arrangements, providing further flexibility and control over the audio output. The user can see the action happening in real time alongside the audio. This can help to create a more believable and engaging audio experience. Additionally, the video can be used to provide supplemental information or context that may not be conveyed through the audio alone. The video can help to illustrate the lyrics or the mood of the song, which can enhance the listener's experience. Additionally, the video can help to keep the listener's attention focused on the song, particularly if the video is engaging or visually interesting. The accompanying video can provide a visual representation of the audio mix, which can be helpful for users who are trying to understand the mix or for musicians who are trying to replicate the mix.

The identifying of the one or more target audio attributes may comprise mapping the one or more target audio arrangement characteristics to the one or more target audio attributes. This provides an objective technique to identify and select audio data most relevant to the end user.

The outputting may comprise streaming the one or more mixed audio arrangements. One advantage of streaming is that it allows users to access content without having to download it first. This is especially useful for large files, such as videos or songs, which can take up a lot of storage space on a device. Streaming also allows people to listen to audio on-demand, which is convenient for both individual listeners and businesses. Additionally, streaming can be used to broadcast audio content to a large audience. This makes it a more convenient option for listeners, especially when streaming over a slow internet connection. Streaming audio rather than transmitting it through a download can be more efficient, as the server only sends data as it is needed rather than an entire file at once. This also makes it more convenient for the listener, as they do not have to wait for the entire file to download before they can start listening. Additionally, streaming can allow for real-time listener feedback, which can be used to improve the mix. Say, for instance, the user requests for the drums playing in a mixed audio arrangement to be changed to a new style of drums. This is only possible on the fly due to streaming. Streaming can provide listeners with a more interactive experience. For example, users and/or listeners can interact with the audio content in real-time for other users and/or listeners to hear the interacted audio in real-time. This type of interaction is not possible with content that is downloaded and stored on a listener's device. Also, it is useful for any type of broadcast, sensor, machine, the audio stream can react and update in real-time. Streaming music is important for interoperability inside the metaverse virtual worlds because it allows people to share and enjoy music together regardless of what platform they are on. People can listen to and interact with the audio arrangement at the same time, chat about it and collaborate while they are in the same virtual world. This helps to create a more unified and connected experience for everyone involved. Streaming also enables tracking real-time arrangements for royalty flows that could be distributed back to the creators anywhere in the world in real-time, especially if there is an end-to-end system in place and/or if blockchain is leveraged. Streaming further allows real-time analysis of the stream and user interactions, such as location of users on the stream, how many users are streaming etc., which is not available if audio is purely local on disk.

Various measures (for example, methods, systems and computer programs) are provided for use in generating an audio arrangement. A template is selected to define permissible audio data for a mixed audio arrangement. The permissible audio data has a set of one or more target audio attributes compatible with the mixed audio arrangement. The set of one or more target audio attributes may fulfil one or more identified audio arrangement characteristics of the audio arrangement, or at least may not reject the possibility of fulfilling the one or more identified audio arrangement characteristics. First audio data is selected. The first audio data has a first set of audio attributes. The first set of audio attributes comprises at least some of the identified one or more target audio attributes. Second audio data is selected. The second audio data has a second set of audio attributes. The second set of audio attributes comprises at least some of the identified one or more target audio attributes. A mixed audio arrangement and/or data useable to generate the mixed audio arrangement is output. The mixed audio arrangement is generated by mixing the selected first and second audio data using an automated audio mixing procedure.

Various measures (for example, methods, systems and computer programs) are provided for use in generating an audio arrangement. Video data is analyzed. One or more target audio arrangement intensities are identified based on said analyzing. One or more target audio attributes are identified based on the one or more target audio arrangement intensities. First audio data is selected. The first audio data has a first set of audio attributes. The first set of audio attributes comprise at least some of the identified one or more target audio attributes. Second audio data is selected. The second audio data has a second set of audio attributes. The second set of audio attributes comprises at least some of the identified one or more target audio attributes. A mixed audio arrangement and/or data useable to generate the mixed audio arrangement is generated and output. The mixed audio arrangement is generated by mixing the selected first and second audio data.

Unless the context indicates otherwise, features from different embodiments and/or examples may be combined with each other. Features and/or techniques are described above by way of example only.

By way of a summary, the process from content creator to end user may be outlined as follows. The assets are created. In order for assets to be fully utilized, they are created following several specific instructions and conventions. The content is pre-processed and organized. Once the assets are received, further processing is performed to extract further data and the asserts are processed into their final form (e.g. spliced, normalized etc.). This enables creators not to have to perform these acts themselves. An arrangement request is analyzed, and it is determined out how that translates to selecting appropriate assets. The appropriate assets are selected, following the above brief and the overall rules that composers have specified. The assets are mixed together and delivered to the end user.

Examples described herein enable data mining and/or harvesting for ML purposes. Input data may be based on: (i) the way users interact with the interface; (ii) the way users rate and/or use different arrangements produced by the system (e.g. whether they like a particular arrangement, whether they used it as a soundtrack for a wedding video or a vacation video etc.); (iii) the audio content itself, as submitted by the creators; (iv) tags assigned to the content by the creators; and/or (v) otherwise. The purpose of collecting this data may include: (i) the automatic tagging and classification of audio assets; (ii) the automatic tagging, classification, and/or rating of arrangements/compositions; and/or (iii) otherwise.

The actual mixing of the audio files may happen entirely on a server, entirely on an end-user's device, or may involve a hybrid mix between the two. Mixing may therefore be optimized according to memory and bandwidth usage constraints and requirements.

At least some of the methods described herein are computer-implemented. As such, computer-implemented methods are provided.

Examples described above relate to rendering audio and, in particular, to rendering an audio arrangement. The techniques described herein may be used to generate other types of media and media arrangement. For example, the techniques described herein may be used to generate video arrangements.

In examples described herein, various actions are taken in response to a request for an audio arrangement being received. Such actions may be triggered in other ways. For example, such actions may be triggered periodically, proactively, etc.

In examples described herein, an automated mixing procedure is performed. Different automated mixing procedures involve different amounts of automation. For example, some automated mixing procedures may be guided by initial user input, some may be fully automated.

### Example Clauses

Implementation examples are described in the following numbered clauses:

Clause 1: A method for use in generating an audio arrangement, the method comprising: receiving a request for an audio arrangement having one or more target audio arrangement characteristics; identifying one or more target audio attributes based on the one or more target audio arrangement characteristics; selecting first audio data, the first audio data having a first set of audio attributes, the first set of audio attributes comprising at least some of the identified one or more target audio attributes; selecting second audio data, the second audio data having a second set of audio attributes, the second set of audio attributes comprising at least some of the identified one or more target audio attributes; and outputting: one or more mixed audio arrangements, the one or more mixed audio arrangements having been generated by at least the selected first and second audio data having been mixed using an automated audio mixing procedure; and/or data useable to generate the one or more mixed audio arrangements.

Clause 2. A method according to clause 1, wherein the one or more target audio arrangement characteristics comprise target audio arrangement intensity.

Clause 3. A method according to clause 2, wherein the target audio arrangement intensity is modifiable after the one or more mixed audio arrangements have been generated.

Clause 4. A method according to clause 2 or 3, comprising: calculating a first spectral weight coefficient of the first audio data based on spectral analysis of the first audio data; and calculating a second spectral weight coefficient of the second audio data based on spectral analysis of the second audio data, wherein the automated mixing of the first and second audio data uses the calculated first and second spectral weight coefficients and is based on the target audio arrangement intensity.

Clause 5. A method according to any of clauses 2 to 4, wherein the first set of audio attributes comprises a first creator-specified spectral weight coefficient, wherein the second set of audio attributes comprises a second creator-specified spectral weight coefficient, and wherein the selecting of the first audio data and the selecting of the second audio data are based on the first and second creator-specified spectral weight coefficients respectively.

Clause 6. A method according to any of clauses 1 to 5, comprising mixing the selected first audio data and the selected second audio data using the automated audio mixing procedure to generate the one or more mixed audio arrangements.

Clause 7. A method according to any of clauses 1 to 6, wherein the one or more target audio arrangement characteristics comprise target audio arrangement duration.

Clause 8. A method according to clause 7, wherein the first set of audio attributes comprises a first duration of the first audio data, wherein the second set of audio attributes comprises a second duration of the second audio data, and wherein the selecting of the first audio data and the selecting of the second audio data are based on the first and second durations respectively.

Clause 9. A method according to any of clauses 1 to 8, wherein the one or more target audio arrangement characteristics comprise genre, theme, style and/or mood.

Clause 10. A method according to any of clauses 1 to 9, comprising: receiving a further request for a further audio arrangement having one or more further target audio arrangement characteristics; identifying one or more further target audio attributes based on the one or more further target audio arrangement characteristics; selecting the first audio data, the first set of audio attributes comprising at least some of the identified one or more further target audio attributes; selecting third audio data, the third audio data having a third set of audio attributes, the third set of audio attributes comprising at least some of the identified one or more further target audio attributes; and outputting: a further mixed audio arrangement, the further mixed audio arrangement having been generated by at least the selected first and third audio data having been mixed using the automated audio mixing procedure; and/or data useable to generate the further mixed audio arrangement.

Clause 11. A method according to any of clauses 1 to 10, comprising deriving the first and/or second audio data using an automated audio normalization procedure.

Clause 12. A method according to any of clauses 1 to 11, comprising deriving the first and/or second audio data using an automated audio mastering procedure.

Clause 13. A method according to any of clauses 1 to 12, wherein the one or more audio arrangements are mixed independent of any user input received after the selection of the first and second audio data.

Clause 14. A method according to any of clauses 1 to 13, wherein the first and/or second set of audio attributes comprises at least one inhibited audio attribute, the at least one inhibited audio attribute indicating an attribute of audio data which is not to be used with the first and/or second audio data, and wherein the selection of the first and/or second audio data is based on the at least one inhibited audio attribute.

Clause 15. A method according to clause 14, wherein further audio data is disregarded for selection for use in the audio arrangement based on the further audio data having at least some of the at least one inhibited audio attributes.

Clause 16. A method according to any of clauses 1 to 15, wherein the first and/or second audio data comprises: a lead-in; primary musical content and/or body; a lead-out; and/or an audio tail.

Clause 17. A method according to any of clauses 1 to 16, wherein only a portion of the first and/or second audio data is used in the audio arrangement.

Clause 18. A method according to any of clauses 1 to 17, wherein the first audio data originates from a first creator and the second audio data originates from a second, different creator.

Clause 19. A method according to any of clauses 1 to 18, wherein the audio arrangement is based further on video data.

Clause 20. A method according to clause 19, comprising analyzing the video data.

Clause 21. A method according to clause 20, comprising identifying the one or more target audio arrangement characteristics based on the analysis of the video data.

Clause 22. A method according to any of clauses 1 to 21, comprising outputting video data to accompany the one or more mixed audio arrangements and/or the data useable to generate the one or more mixed audio arrangements.

Clause 23. A method according to any of clauses 1 to 22, wherein the identifying of the one or more target audio attributes comprises mapping the one or more target audio arrangement characteristics to the one or more target audio attributes.

Clause 24. A method according to any of clauses 1 to 23, wherein said outputting comprises streaming the one or more mixed audio arrangements.

Clause 25. A method for use in generating an audio arrangement, the method comprising: selecting a template to define permissible audio data for a mixed audio arrangement, the permissible audio data having a set of one or more target audio attributes compatible with the mixed audio arrangement; selecting first audio data, the first audio data having a first set of audio attributes, the first set of audio attributes comprising at least some of the identified one or more target audio attributes; selecting second audio data, the second audio data having a second set of audio attributes, the second set of audio attributes comprising at least some of the identified one or more target audio attributes; generating one or more mixed audio arrangements and/or data useable to generate the one or more mixed audio arrangement, the one or more mixed audio arrangements being generated by mixing the selected first and second audio data using an automated audio mixing procedure; and outputting said one or more generated mixed audio arrangements and/or data useable to generate the one or more mixed audio arrangements.

Clause 26. A method for use in generating an audio arrangement, the method comprising: analyzing video data and/or given audio data; identifying one or more target audio arrangement intensities based on the analysis of the video data and/or given audio data; identifying one or more target audio attributes based on the one or more target audio arrangement intensities; selecting first audio data, the first audio data having a first set of audio attributes, the first set of audio attributes comprising at least some of the identified one or more target audio attributes; selecting second audio data, the second audio data having a second set of audio attributes, the second set of audio attributes comprising at least some of the identified one or more target audio attributes; and generating one or more mixed audio arrangements and/or data useable to generate the one or more mixed audio arrangements, the one or more mixed audio arrangements being generated by mixing the selected first and second audio data; and outputting said one or more generated mixed audio arrangements and/or data useable to generate the one or more mixed audio arrangements.

Clause 27. A system configured to perform a method according to any of clauses 1 to 26.

Clause 28. A computer program arranged, when executed, to perform a method according to any of clauses 1 to 26.

1. A method for use in generating an audio arrangement, the method comprising:
receiving a request for an audio arrangement having one or more target audio arrangement characteristics;
identifying one or more target audio attributes based on the one or more target audio arrangement characteristics;
selecting first audio data, the first audio data having a first set of audio attributes, the first set of audio attributes comprising at least some of the identified one or more target audio attributes;
selecting second audio data, the second audio data having a second set of audio attributes, the second set of audio attributes comprising at least some of the identified one or more target audio attributes; and
outputting:
one or more mixed audio arrangements, the one or more mixed audio arrangements having been generated by at least the selected first and second audio data having been mixed using an automated audio mixing procedure; or
data useable to generate the one or more mixed audio arrangements.

2. The method of claim 1, wherein the one or more target audio arrangement characteristics comprise target audio arrangement intensity.

3. The method of claim 2, wherein the target audio arrangement intensity is modifiable after the one or more mixed audio arrangements have been generated.

4. The method of claim 2, comprising:
calculating a first spectral weight coefficient of the first audio data based on spectral analysis of the first audio data; and
calculating a second spectral weight coefficient of the second audio data based on spectral analysis of the second audio data,
wherein the automated mixing of the first and second audio data uses the calculated first and second spectral weight coefficients and is based on the target audio arrangement intensity.

5. The method of claim 2, wherein the first set of audio attributes comprises a first creator-specified spectral weight coefficient, wherein the second set of audio attributes comprises a second creator-specified spectral weight coefficient, and wherein the selecting of the first audio data and the selecting of the second audio data are based on the first and second creator-specified spectral weight coefficients respectively.

6. The method of 1, comprising mixing the selected first audio data and the selected second audio data using the automated audio mixing procedure to generate the one or more mixed audio arrangements.

7. The method of claim 1, wherein the one or more target audio arrangement characteristics comprise target audio arrangement duration.

8. The method of claim 7, wherein the first set of audio attributes comprises a first duration of the first audio data, wherein the second set of audio attributes comprises a second duration of the second audio data, and wherein the selecting of the first audio data and the selecting of the second audio data are based on the first and second durations respectively.

9. The method of claim 1, wherein the one or more target audio arrangement characteristics comprise genre, theme, style or mood.

10. The method of claim 1, comprising:
receiving a further request for a further audio arrangement having one or more further target audio arrangement characteristics;
identifying one or more further target audio attributes based on the one or more further target audio arrangement characteristics;
selecting the first audio data, the first set of audio attributes comprising at least some of the identified one or more further target audio attributes;
selecting third audio data, the third audio data having a third set of audio attributes, the third set of audio attributes comprising at least some of the identified one or more further target audio attributes; and
outputting:
a further mixed audio arrangement, the further mixed audio arrangement having been generated by at least the selected first and third audio data having been mixed using the automated audio mixing procedure; or
data useable to generate the further mixed audio arrangement.

11. The method according of claim 1, comprising deriving the first audio data or the second audio data using an automated audio normalization procedure.

12. The method of claim 1, comprising deriving the first audio data for the second audio data using an automated audio mastering procedure.

13. The method of claim 1, wherein the one or more audio arrangements are mixed independent of any user input received after the selection of the first and second audio data.

14. The method of claim 1, wherein the first set of audio attributes or the second set of audio attributes comprises at least one inhibited audio attribute, the at least one inhibited audio attribute indicating an attribute of audio data which is not to be used with the first audio data or the second audio data, and wherein the selection of the first audio data or the second audio data is based on the at least one inhibited audio attribute.

15. The method of claim 14, wherein further audio data is disregarded for selection for use in the audio arrangement based on the further audio data having at least some of the at least one inhibited audio attributes.

16. The method of claim 1, wherein the first audio data or the second audio data comprises:
a lead-in;
a primary musical content or body;
a lead-out; or
an audio tail.

17. The method of claim 1, wherein only a portion of the first audio data or the second audio data is used in the audio arrangement.

18. The method of claim 1, wherein the first audio data originates from a first creator and the second audio data originates from a second, different creator.

19. The method of claim 1, wherein the audio arrangement is based further on video data.

20. The method of claim 19, comprising analyzing the video data.

21. The method of claim 20, comprising identifying the one or more target audio arrangement characteristics based on the analyzing of the video data.

22. The method of claim 1, comprising outputting video data to accompany the one or more mixed audio arrangements or the data useable to generate the one or more mixed audio arrangements.

23. The method of claim 1, wherein the identifying of the one or more target audio attributes comprises mapping the one or more target audio arrangement characteristics to the one or more target audio attributes.

24. The method of claim 1, wherein said outputting comprises streaming the one or more mixed audio arrangements.

25. A method for use in generating an audio arrangement, the method comprising:
selecting a template to define permissible audio data for a mixed audio arrangement, the permissible audio data having a set of one or more target audio attributes compatible with the mixed audio arrangement;
selecting first audio data, the first audio data having a first set of audio attributes, the first set of audio attributes comprising at least some of the identified one or more target audio attributes;
selecting second audio data, the second audio data having a second set of audio attributes, the second set of audio attributes comprising at least some of the identified one or more target audio attributes;
generating one or more mixed audio arrangements and/or data useable to generate the one or more mixed audio arrangement, the one or more mixed audio arrangements being generated by mixing the selected first and second audio data using an automated audio mixing procedure; and
outputting said one or more generated mixed audio arrangements or data useable to generate the one or more mixed audio arrangements.

26. A method for use in generating an audio arrangement, the method comprising:
analyzing video data or given audio data;
identifying one or more target audio arrangement intensities based on the analyzing of the video data and/or given audio data;
identifying one or more target audio attributes based on the one or more target audio arrangement intensities;
selecting first audio data, the first audio data having a first set of audio attributes, the first set of audio attributes comprising at least some of the identified one or more target audio attributes;
selecting second audio data, the second audio data having a second set of audio attributes, the second set of audio attributes comprising at least some of the identified one or more target audio attributes; and
generating one or more mixed audio arrangements and/or data useable to generate the one or more mixed audio arrangements, the one or more mixed audio arrangements being generated by mixing the selected first and second audio data; and
outputting said one or more generated mixed audio arrangements and/or data useable to generate the one or more mixed audio arrangements.

27. A system, comprising:
one or more processors; and
a memory comprising instructions that when executed by the one or more processors, cause the system to:
receive a request for an audio arrangement having one or more target audio arrangement characteristics;
identify one or more target audio attributes based on the one or more target audio arrangement characteristics;
select first audio data, the first audio data having a first set of audio attributes, the first set of audio attributes comprising at least some of the identified one or more target audio attributes;
select second audio data, the second audio data having a second set of audio attributes, the second set of audio attributes comprising at least some of the identified one or more target audio attributes; and
output:
one or more mixed audio arrangements, the one or more mixed audio arrangements having been generated by at least the selected first and second audio data having been mixed using an automated audio mixing procedure; or
data useable to generate the one or more mixed audio arrangements.

28. A non-transitory computer-readable medium comprising instructions that, when executed by one or more processors of a computing system, cause the computing system to:
receive a request for an audio arrangement having one or more target audio arrangement characteristics;
identify one or more target audio attributes based on the one or more target audio arrangement characteristics;
select first audio data, the first audio data having a first set of audio attributes the first set of audio attributes comprising at least some of the identified one or more target audio attributes;
select second audio data the second audio data having a second set of audio attributes, the second set of audio attributes comprising at least some of the identified one or more target audio attributes; and
output:
one or more mixed audio arrangements, the one or more mixed audio arrangements having been generated by at least the selected first and second audio data having been mixed using an automated audio mixing procedure; or
data useable to generate the one or more mixed audio arrangements.
